(19) United States
(12) Patent Application Publication
(10) Pub. No.: US 2025/0273369 A1
(43) Pub. Date: Aug. 28, 2025

(54) THIN RESISTOR AND MANUFACTURING METHOD THEREOF

(71) Applicant: YAGEO CORPORATION, Kaohsiung City (TW)

(72) Inventors: Ren-Hong WANG, Kaohsiung City (TW); Ming-Hung HSIAO, Kaohsiung City (TW)

(21) Appl. No.: 18/764,188

(22) Filed: Jul. 4, 2024

(30) Foreign Application Priority Data
Feb. 23, 2024 (TW) 113106514

(51) Int. Cl. H01C 7/18; H01C 1/14; H01C 17/24; H01C 17/28

(52) U.S. Cl. CPC H01C 7/18; H01C 1/14; H01C 17/24; H01C 17/28

(57) ABSTRACT

A thin resistor includes an insulating layer, a resistive layer, a pair of internal electrodes, a protective layer, and a pair of external electrodes. The resistive layer is disposed on the insulating layer, in which the resistive layer includes a pair of recesses, and the pair of recesses is located on two opposite ends of the resistive layer, respectively. The pair of internal electrodes is respectively disposed in the pair of recesses and on the resistive layer, and top surfaces of the pair of internal electrodes are higher than a top surface of the resistive layer. The protective layer covers a portion of the resistive layer and portions of the internal electrodes. The pair of external electrodes is electrically connected to the pair of internal electrodes.

### RELATED APPLICATION

This application claims priority to Taiwan Application Serial Number 113106514, filed Feb. 23, 2024, which is herein incorporated by reference.

### BACKGROUND

### Field of Invention

The present disclosure relates to a thin resistor and a manufacturing method thereof. More particularly, the present disclosure relates to the thin resistor with a pair of internal electrodes embedded in a resistive layer.

### Description of Related Art

In the field of current sense resistors, a resistance value of a resistor can usually be reduced by increasing a thickness of a resistive layer or reducing the spacing between a pair of internal electrodes. However, a thicker resistive layer can increase an overall size of the resistor, which is disadvantageous to subsequent applications of the resistor. In addition, a narrower spacing between the pair of internal electrodes is disadvantageous to fine adjustment of the resistance value of the resistor, and is also disadvantageous to the control of a temperature coefficient of resistance (TCR) of the resistor.

Furthermore, if the TCR of the resistor is reduced, it will have to increase a thickness of the pair of internal electrodes, so as to reduce the contribution of the pair of internal electrodes to the resistance value of the overall resistor. However, the greater thickness of the pair of inner electrodes will increase the overall size of the resistor, which is disadvantageous to subsequent applications of the resistor.

For the foregoing reason, there is a need to solve the above-mentioned problems by providing a resistor and a manufacturing method thereof.

### SUMMARY

The thin resistor of the present disclosure has a pair of internal electrodes partially embedded in a resistive layer. Therefore, an overall thickness of the thin resistor can be reduced, which is beneficial to the subsequent applications of the thin resistor, as well as the better control of TCR of the thin resistor. Furthermore, because the internal electrodes of the present disclosure are partially embedded in the resistive layer, the current density at both ends of the pair of internal electrodes of the thin resistor of the present disclosure is less (the current between the resistive layer and the internal electrodes is relatively smooth) than the one of the pair of the conventional internal electrodes that does not embed in the resistive layer, resulting in reduced heat accumulation and increased heat conduction capability.

In at least one embodiment of the present disclosure, a thin resistor is provided. The thin resistor includes an insulating layer, a resistive layer, a pair of internal electrodes, a protective layer, and a pair of external electrodes. The resistive layer is disposed on the insulating layer, in which the resistive layer includes a pair of recesses respectively located on two opposite ends of the resistive layer. The pair of internal electrodes is respectively disposed in the pair of recesses and on the resistive layer, and top surfaces of the pair of internal electrodes are higher than a top surface of the resistive layer. The protective layer covers a portion of the resistive layer and portions of the pair of internal electrodes. The pair of external electrodes electrically connects the pair of internal electrodes.

In at least one embodiment of the present disclosure, the resistive layer has a resistance long side and a resistance short side, the resistance long side has a resistance length L, the resistance short side has a resistance width W, each of the pair of recesses has a recess long side and a recess short side, and a shortest vertical distance between the resistance long side and the recess short side is in a range from 0 μm to ⅙ W.

In at least one embodiment of the present disclosure, the resistance length L is in a range from 0.5 mm to 6.5 mm.

In at least one embodiment of the present disclosure, the resistance width W is in a range from 0.25 mm to 3.25 mm.

In at least one embodiment of the present disclosure, a shortest vertical distance between the resistance short side and the recess long side is in a range from 0 μm to 1/10 L.

In at least one embodiment of the present disclosure, the recess short side has a recess width, and the recess width is in a range from 1/7 L to ⅓ L.

In at least one embodiment of the present disclosure, a shortest vertical distance between two recesses is in a range from 1/25 L to ⅓ L.

In at least one embodiment of the present disclosure, the resistive layer has a resistance thickness T, each of the pair of recesses has a recess depth, and the recess depth is in a range from 1/10 T to ⅔ T.

In at least one embodiment of the present disclosure, the resistance thickness T is in a range from 0.075 mm to 0.3 mm.

In at least one embodiment of the present disclosure, top surfaces of the pair of internal electrodes are at least 10 μm higher than a top surface of the resistive layer.

In at least one embodiment of the present disclosure, the pair of external electrodes includes a pair of front electrodes, and top surfaces of the front electrodes are at least 5 μm higher than a top surface of the protective layer.

In at least one embodiment of the present disclosure, the pair of external electrodes further includes a pair of nickel layers and a pair of tin layers. The pair of nickel layers covers the pair of front electrodes. The pair of tin layers covers the pair of nickel layers.

In at least one embodiment of the present disclosure, a manufacturing method of a thin resistor is provided. A resistive layer is formed on an insulating layer. Portions of the insulating layer are recessed to form a pair of recesses, in which the pair of recesses is respectively located on opposite sides of the resistive layer. A pair of internal electrodes is formed in the pair of recesses, in which top surfaces of the pair of internal electrodes are higher than a top surface of the resistive layer. A protective layer is formed to cover a first portion of the resistive layer and portions of the pair of internal electrodes. A pair of external electrodes is formed to electrically connect the pair of internal electrodes.

In at least one embodiment of the present disclosure, after forming the pair of internal electrodes, performing a trimming operation on the resistive layer.

In at least one embodiment of the present disclosure, the pair of internal electrodes is formed by electroplating.

In at least one embodiment of the present disclosure, the pair of recesses is formed by an etching process.

In at least one embodiment of the present disclosure, an etching solution used in the etching process includes copper chloride, sulfuric acid, phosphoric acid, nitric acid, or combinations thereof.

In at least one embodiment of the present disclosure, further comprising: before recessing the portions of the insulating layer to form the pair of recesses, forming a mask layer on the resistive layer; and after recessing the portions of the insulating layer to form the pair of recesses, removing the mask layer to expose the top surface of the resistive layer.

In at least one embodiment of the present disclosure, further comprising: before forming the pair of internal electrodes in the pair of recesses, forming a mask layer to cover a second portion of the resistive layer and expose the pair of recesses; and after forming the pair of internal electrodes in the pair of recesses, removing the mask layer to expose the top surface of the resistive layer.

In at least one embodiment of the present disclosure, further comprising: after removing the mask layer to expose the top surface of the resistive layer, performing a trimming operation on the resistive layer to form a trimming groove.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 and FIG. 2 are cross-sectional views of a thin resistor according to one embodiment of the present disclosure.

FIG. 3A, FIG. 4A, FIG. 5A, FIG. 6A, FIG. 7A, and FIG. 8A are three-dimensional diagrams of a thin resistor at various stages in accordance with one embodiment of the present disclosure.

FIG. 3B, FIG. 4B, FIG. 5B, FIG. 6B, FIG. 7B, and FIG. 8B are cross-sectional views obtained from lines A-A′ of FIG. 3A, FIG. 4A, FIG. 5A, FIG. 6A, FIG. 7A, and FIG. 8A, respectively.

FIG. 4C is a three-dimensional diagram of a resistive layer of FIG. 4A.

### DETAILED DESCRIPTION

The following disclosure provides many different embodiments, or examples, for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly.

In the present specification, a range represented by “one value to another value” is a summary representation that avoids enumerating all the values in the range in the specification. Therefore, the recitation of a particular numerical range covers any numerical value within the numerical range and the smaller numerical range defined by any numerical values within the numerical range, as if the arbitrary value and the smaller numerical range are expressly stated in the specification.

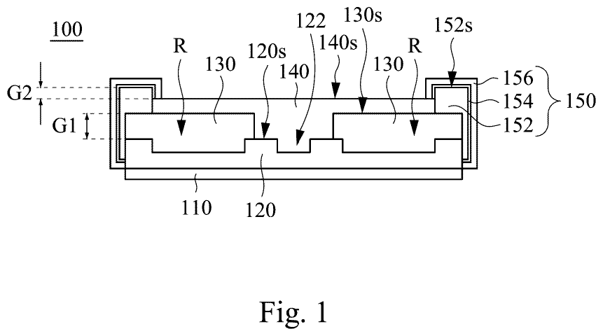

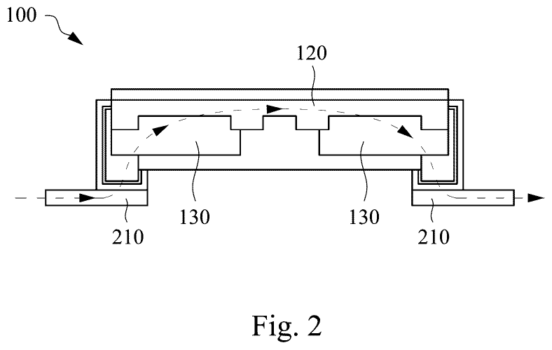

FIG. 1 and FIG. 2 are cross-sectional views of a thin resistor 100 according to one embodiment of the present disclosure. Referring to FIG. 1, the thin resistor 100 includes an insulating layer 110, a resistive layer 120, and a pair of internal electrodes 130. The resistive layer 120 is disposed on the insulating layer 110, in which the resistive layer 120 includes a trimming groove 122. The resistive layer 120 includes a pair of recesses R, and the pair of recesses R is respectively located on two opposite ends of the resistive layer 120. The pair of internal electrodes 130 is respectively disposed in the pair of recesses R and on the resistive layer 120. In other words, portions of the internal electrodes 130 are embedded in the resistive layer 120, and other portions of the internal electrodes 130 protrude from a top surface 120s of the resistive layer 120.

In the embodiment of FIG. 1, top surfaces 130s of the internal electrodes 130 are higher than the top surface 120s of the resistive layer 120. In some embodiments, a gap G1 between the top surfaces 130s of the internal electrodes 130 and the top surface 120s of the resistive layer 120 is at least 10 μm. If the gap G1 was less than 10 μm, it would be disadvantageous to adjust a resistance value of the internal electrodes 130 by using a probe in the subsequent process. A bottom surface of the pair of internal electrodes 130 is lower than the top surface 120s of the resistive layer 120. In some embodiments, an overall thickness of the internal electrodes 130 is at least 100 μm. It should be noted that the “overall thickness” of the internal electrodes 130 herein includes the sum of a thickness of the internal electrodes 130 in the recesses R and a thickness of the internal electrodes 130 higher than the top surface 120s of the resistive layer 120.

As shown in FIG. 1, the thin resistor 100 further includes a protective layer 140 and a pair of external electrodes 150 (may be referred to as terminal electrodes). The protective layer 140 covers a portion of the resistive layer 120 and portions of the internal electrodes 130. The pair of external electrodes 150 electrically connects the pair of internal electrodes 130, in which the pair of external electrodes 150 includes a pair of front electrodes 152, a pair of nickel layers 154, and a pair of tin (Sn) layers 156. The pair of front electrodes 152 covers portions of the internal electrodes 130 and two side surfaces of the resistive layer 120. The pair of nickel layers 154 covers the pair of front electrodes 152, and the pair of tin layers 156 covers the pair of nickel layers 154.

In the embodiment of FIG. 1, the top surfaces 152s of the pair of front electrodes 152 are higher than a top surface 140s of the protective layer 140. In some embodiments, a gap G2 between the top surfaces 152s of the pair of front electrodes 152 and the top surface 140s of the protective layer 140 is at least 5 μm. If the gap G2 is less than 5 μm, it would be disadvantageous to soldering of the thin resistor 100 in the subsequent process.

Referring to FIG. 2, FIG. 2 is an inverted structure of FIG. 1, and the thin resistor 100 in FIG. 2 is disposed on pads 210, in which the dashed arrows represent the direction of current. It can be known from FIG. 2 that because the internal electrodes 130 of the disclosed thin resistor 100 are partially embedded in the resistive layer 120, the current between the resistive layer 120 and internal electrodes 130 is relatively smooth compared with the internal electrodes that do not embed in the resistive layer. Therefore, heat accumulation at both ends of the internal electrodes 130 can be reduced, thereby increasing the heat conduction capability. Furthermore, because the internal electrodes 130 are partially embedded in the resistive layer 120, the overall thickness of the resistor can be reduced, which is beneficial to the subsequent applications of the resistor and is beneficial for controlling TCR of the resistor.

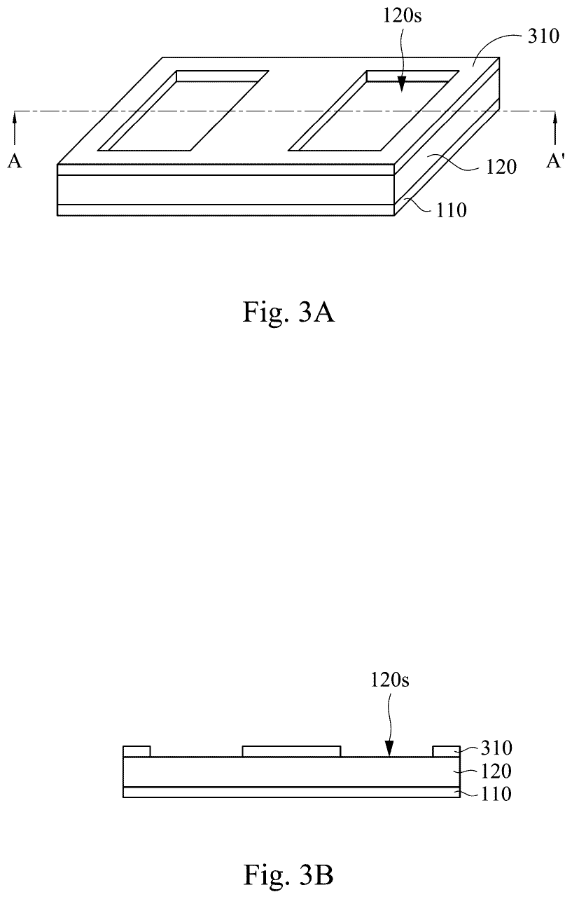

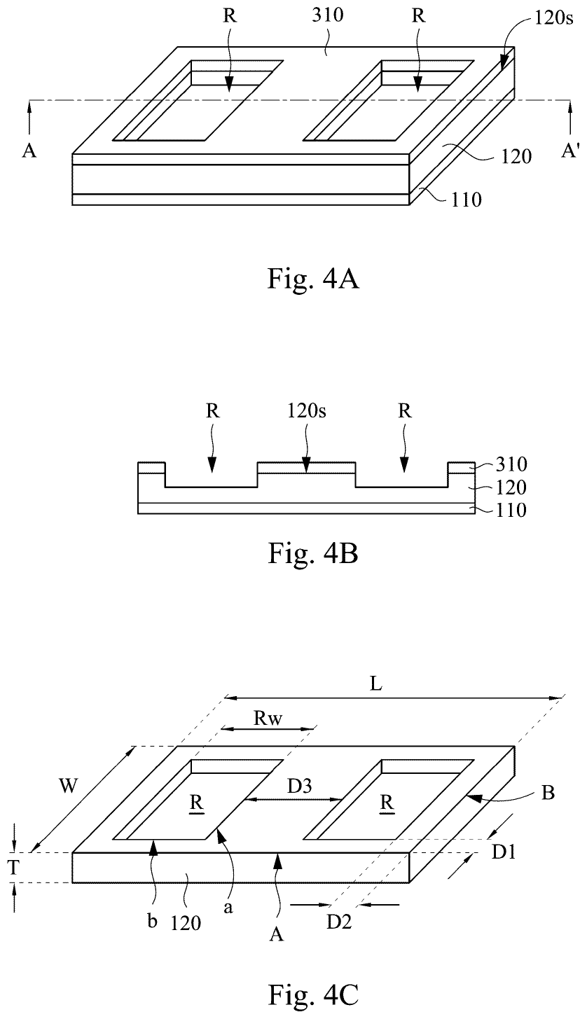

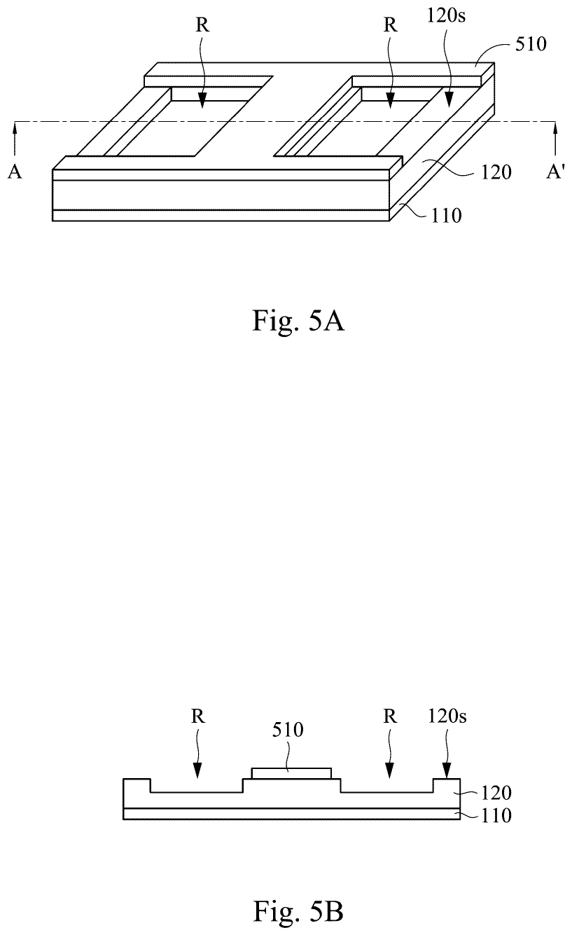

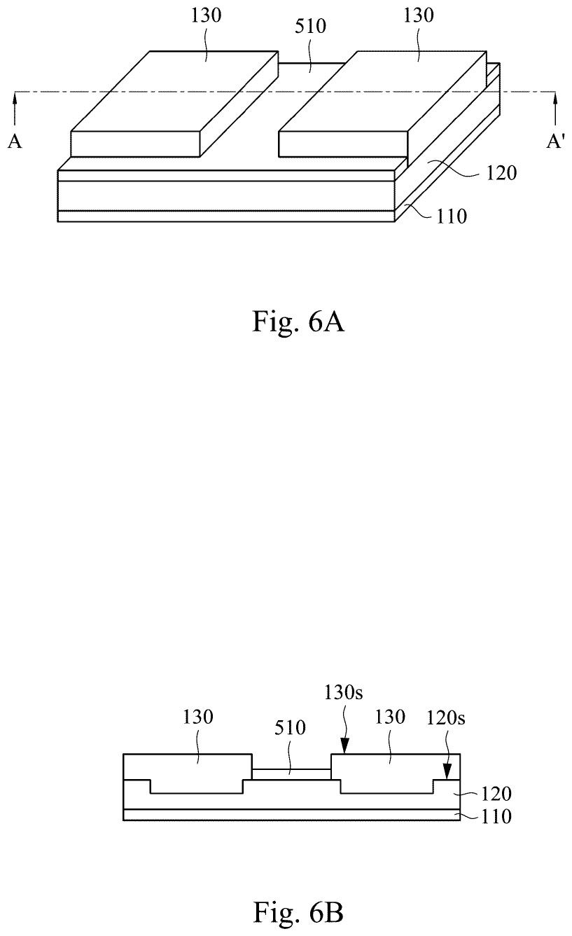

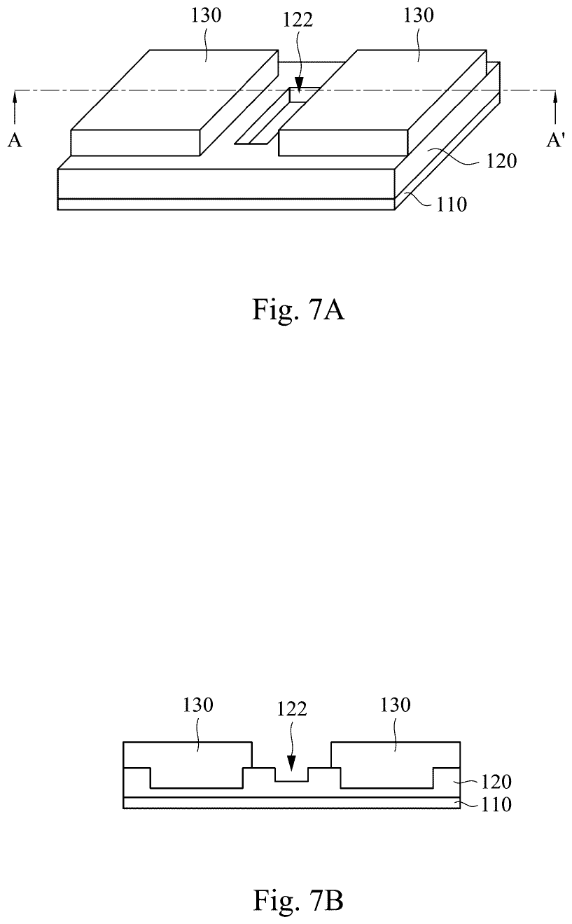

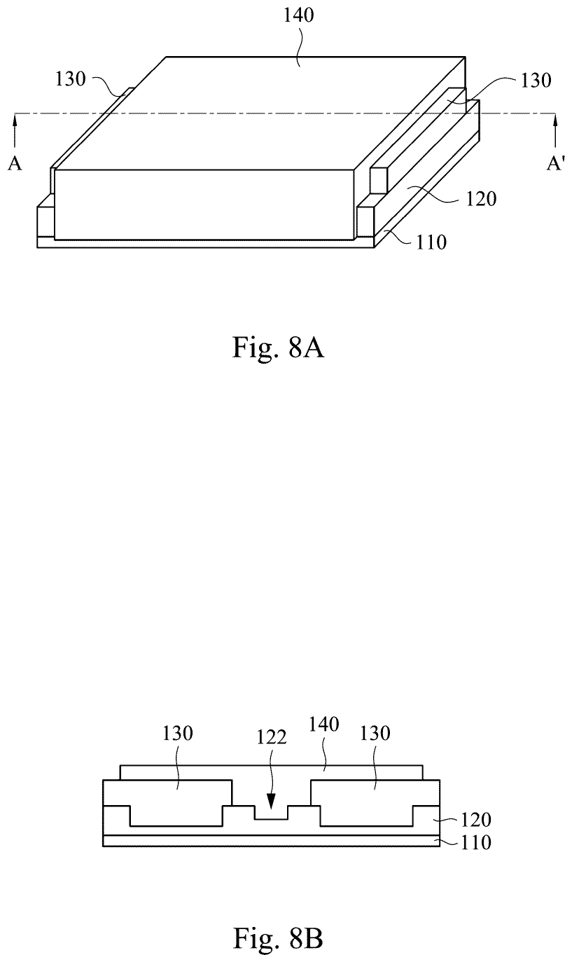

FIG. 3A, FIG. 4A, FIG. 5A, FIG. 6A, FIG. 7A, and FIG. 8A are three-dimensional diagrams of the thin resistor 100 at various stages in accordance with one embodiment of the present disclosure. FIG. 3B, FIG. 4B, FIG. 5B, FIG. 6B, FIG. 7B, and FIG. 8B are cross-sectional views obtained from lines A-A′ of FIG. 3A, FIG. 4A, FIG. 5A, FIG. 6A, FIG. 7A, and FIG. 8A, respectively.

Referring to FIG. 3A and FIG. 3B, the resistive layer 120 is formed on the insulating layer 110. In some embodiments, the insulating layer 110 is a carrier with a single-sided adhesive. In some embodiments, the carrier includes an insulating material, such as polyimide (PI), glass fiber epoxy resin (FR4), ceramic substrate, or glass substrate, but is not limited thereto. In other embodiments, the insulating layer 110 (carrier) and the resistive layer 120 are bonded together using a double-sided adhesion layer.

In some embodiments, the resistive layer 120 includes a metallic alloy material, such as a MnCu alloy, a CuNi alloy, a CuMnNi alloy, a CuMnSn alloy, a NiCrAl alloy, a NiCrAlSi alloy, or a FeCrAl alloy, but is not limited thereto.

Still referring to FIG. 3A and FIG. 3B, the mask layer 310 is formed on the resistive layer 120, so as to cover a portion of the resistive layer 120 and expose other portions of the top surfaces 120s of the resistive layer 120. In some embodiments, the patterned mask layer 310 is formed by printing, laminating, coating, and/or photolithography. A material of the mask layer 310 could include a photoresist material, a removable adhesive film, or ink. It could be understood that the exposed top surfaces 120s are areas where subsequent etching operations could be performed. Although the mask layer 310 shown in FIG. 3A includes two rectangles, the pattern of the mask layer 310 could be adjusted according to actual needs.

Referring to FIG. 4A and FIG. 4B, portions of the insulating layer 110 are recessed to form the pair of recesses R, in which the pair of recesses R is respectively located on two opposite ends of the resistive layer 120. Specifically, the pair of recesses R is formed by an etching process. In some embodiments, an etching solution used in the etching process includes copper chloride, sulfuric acid, phosphoric acid, nitric acid, or combinations thereof. It could be understood that two recesses R of the present disclosure are symmetrically arranged and have the same or similar dimensions.

Referring to FIG. 4C, FIG. 4C is a three-dimensional diagram of the resistive layer 120 of FIG. 4A. The resistive layer 120 has a resistance long side A and a resistance short side B, in which the resistance long side A has a resistance length L, and the resistance short side B has a resistance width W. Each of the recesses R has a recess long side a and a recess short side b. In some embodiments, the resistance length L is in a range from 0.5 mm to 6.5 mm. In some embodiments, the resistance width W is in a range from 0.25 mm to 3.25 mm.

In some embodiments, a shortest vertical distance D1 between the resistance long side A and the recess short side b is in a range from 0 μm to ⅙ W. If the distance D1 was greater than ⅙ W, it would be disadvantageous to finely adjust the resistance value of the resistive layer 120.

In some embodiments, a shortest vertical distance D2 between the resistance short side B and the recess long side a is in a range from 0 μm to 1/10 L. If the distance D2 was greater than 1/10 L, it would be disadvantageous to finely adjust the resistance value of the resistive layer 120. It could be understood that a cross-section of the resistive layer 120 has a T-like profile when both the distance D1 and the distance D2 are 0 μm.

In some embodiments, a shortest vertical distance D3 between two recesses R is in a range from 1/25 L to ⅓ L.

Still referring to FIG. 4C, in some embodiments, the recess short side b has a recess width Rw, and a recess width Rw is in a range from 1/7 L to ⅓ L. The wider the recess width Rw, the bigger the internal electrodes (i.e., the internal electrodes 130 in FIG. 1) formed in the subsequent processes and the smaller the overall resistance value of the resistor. The narrower the recess width Rw, the smaller the internal electrodes (i.e., the internal electrodes 130 in FIG. 1) formed in the subsequent processes and the greater the overall resistance value of the resistor.

Still referring to FIG. 4C, the resistive layer 120 has a resistance thickness T. In some embodiments, the resistance thickness T is in a range from 0.075 mm to 0.3 mm. In some embodiments, a recess depth of the recess R is in a range from 1/10 T to ⅔ T. If the recess depth is in a range from 1/10 T to ⅔ T, the current flowing through the resistive layer 120 and the internal electrodes 130 (refer to FIG. 2) is smooth, which can reduce heat accumulation and increase the heat conduction capability and the heat dissipation capability. If the recess depth was less than 1/10 T, the thin resistor of the present disclosure could not be formed, and the current flowing through the resistive layer 120 and the internal electrodes 130 would excessively concentrate at the ends of the internal electrodes 130, which is disadvantageous to heat conduction. If the recess depth was greater than ⅔ T, the support of the resistive layer 120 might be insufficient, thereby causing the bended resistor.

After the pair of recesses R shown in FIG. 4A and FIG. 4B is formed, the mask layer 310 is removed, so as to expose the top surface 120s of the resistive layer 120. The mask layer 310 can be removed by using film-removing liquid.

Referring to FIG. 5A and FIG. 5B, the mask layer 510 is formed on the resistive layer 120, so as to cover a portion of the resistive layer 120 and expose other portions of the top surfaces 120s of the resistive layer 120, in which the recesses R are also exposed by the mask layer 510. It is noted that two ends of the top surface 120s of the resistive layer 120 are also exposed by the mask layer 510. In some embodiments, the patterned mask layer 510 is formed by printing, laminating, coating, and/or photolithography. A material of the mask layer 510 could include a photoresist material, a removable adhesive film, or ink.

Referring to FIG. 6A and FIG. 6B, the pair of internal electrodes 130 is formed in the pair of recesses R, in which the top surfaces 130s of the internal electrodes 130 are higher than the top surface 120s of the resistive layer 120. The pair of internal electrodes 130 is formed by electroplating. A material of the internal electrodes 130 includes copper. It could be understood that the pair of internal electrodes 130 is firstly formed by filling the pair of recesses R (refer to FIG. 5A and FIG. 5B), and then continuing to form copper material (or other material of internal electrodes), so as to form the pair of internal electrodes 130 protruding from the top surface 120s of the resistive layer 120. As shown in FIG. 6B, a cross-section of each of the internal electrodes 130 has a T-like profile.

After the internal electrodes 130 shown in FIG. 6A and FIG. 6B are formed, the mask layer 510 is removed, so as to expose the top surface 120s of the resistive layer 120. The mask layer 510 can be removed by using film-removing liquid.

Referring to FIG. 7A and FIG. 7B, a trimming operation is performed on the resistive layer 120 to form a trimming groove 122. In some embodiments, trimming groove 122 is formed by laser or physical processing.

Referring to FIG. 8A and FIG. 8B, the protective layer 140 is formed, so as to cover a portion of the resistive layer 120 and portions of the internal electrodes 130. In some embodiments, a material of the protective layer 140 includes epoxy or resin. In some embodiments, the insulating protective layer 140 is formed by printing or photolithography.

After the protective layer 140 is formed, the pair of external electrodes 150 is formed to electrically connect the pair of internal electrodes 130, as shown in FIG. 1. The nickel layer 154 and the tin layer 156 are formed by electroplating.

It could be understood that the dimensions (i.e., the resistance length L, the resistance width W, and the resistance thickness T) of the disclosed resistive layer 120 can be arbitrarily enlarged or reduced according to the actual applications of the resistor and the actual needs of the product, and is not particularly limited.

In summary, the thin resistor of the present disclosure has the pair of internal electrodes partially embedded in the resistive layer. Therefore, the overall thickness of the film resistor can be reduced, which is beneficial to the subsequent applications of the thin resistor, as well as the better control of TCR of the thin resistor. Furthermore, because the internal electrodes of the present disclosure are partially embedded in the resistive layer, the current density at both ends of the pair of internal electrodes of the thin resistor of the present disclosure is less (the current between the resistive layer and the internal electrodes is relatively smooth) than the one of the pair of the conventional internal electrodes that does not embed in the resistive layer, resulting in reduced heat accumulation and increased heat conduction capability.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A thin resistor, comprising:
an insulating layer;
a resistive layer disposed on the insulating layer, wherein the resistive layer includes a pair of recesses located on two opposite ends of the resistive layer, respectively;
a pair of internal electrodes respectively disposed in the pair of recesses and on the resistive layer, wherein top surfaces of the pair of internal electrodes are higher than a top surface of the resistive layer;
a protective layer covering a portion of the resistive layer and portions of the pair of internal electrodes; and
a pair of external electrodes electrically connecting the pair of internal electrodes.

2. The thin resistor of claim 1, wherein the resistive layer has a resistance long side and a resistance short side, the resistance long side has a resistance length L, the resistance short side has a resistance width W, each of the pair of recesses has a recess long side and a recess short side, and a shortest vertical distance between the resistance long side and the recess short side is in a range from 0 μm to ⅙ W.

3. The thin resistor of claim 2, wherein the resistance length L is in a range from 0.5 mm to 6.5 mm.

4. The thin resistor of claim 2, wherein the resistance width W is in a range from 0.25 mm to 3.25 mm.

5. The thin resistor of claim 2, wherein a shortest vertical distance between the resistance short side and the recess long side is in a range from 0 μm to 1/10 L.

6. The thin resistor of claim 2, wherein the recess short side has a recess width, and the recess width is in a range from 1/7 L to ⅓ L.

7. The thin resistor of claim 2, wherein a shortest vertical distance between two recesses is in a range from 1/25 L to ⅓ L.

8. The thin resistor of claim 1, wherein the resistive layer has a resistance thickness T, each of the pair of recesses has a recess depth, and the recess depth is in a range from 1/10 T to ⅔ T.

9. The thin resistor of claim 8, wherein the resistance thickness T is in a range from 0.075 mm to 0.3 mm.

10. The thin resistor of claim 1, wherein the top surfaces of the pair of internal electrodes are at least 10 μm higher than the top surface of the resistive layer.

11. The thin resistor of claim 1, wherein the pair of external electrodes comprises a pair of front electrodes, and top surfaces of the pair of front electrodes are at least 5 μm higher than a top surface of the protective layer.

12. The thin resistor of claim 11, wherein the pair of external electrodes further comprises:
a pair of nickel layers covering the pair of front electrodes; and
a pair of tin layers covering the pair of nickel layers.

13. A manufacturing method of a thin resistor, comprising:
forming a resistive layer on an insulating layer;
recessing portions of the insulating layer to form a pair of recesses, wherein the pair of recesses is located on two opposite ends of the resistive layer, respectively;
forming a pair of internal electrodes in the pair of recesses, wherein top surfaces of the pair of internal electrodes are higher than a top surface of the resistive layer;
forming a protective layer to cover a first portion of the resistive layer and portions of the pair of internal electrodes; and
forming a pair of external electrodes to electrically connect the pair of internal electrodes.

14. The manufacturing method of the thin resistor of claim 13, wherein after forming the pair of internal electrodes, performing a trimming operation on the resistive layer.

15. The manufacturing method of the thin resistor of claim 13, wherein the pair of internal electrodes is formed by electroplating.

16. The manufacturing method of the thin resistor of claim 13, wherein the pair of recesses is formed by an etching process.

17. The manufacturing method of the thin resistor of claim 16, wherein an etching solution used in the etching process comprises copper chloride, sulfuric acid, phosphoric acid, nitric acid, or combinations thereof.

18. The manufacturing method of the thin resistor of claim 13, further comprising:
before recessing the portions of the insulating layer to form the pair of recesses, forming a mask layer on the resistive layer; and
after recessing the portions of the insulating layer to form the pair of recesses, removing the mask layer to expose the top surface of the resistive layer.

19. The manufacturing method of the thin resistor of claim 13, further comprising:
before forming the pair of internal electrodes in the pair of recesses, forming a mask layer to cover a second portion of the resistive layer and expose the pair of recesses; and
after forming the pair of internal electrodes in the pair of recesses, removing the mask layer to expose the top surface of the resistive layer.

20. The manufacturing method of the thin resistor of claim 19, further comprising:
after removing the mask layer to expose the top surface of the resistive layer, performing a trimming operation on the resistive layer to form a trimming groove.
